(19) United States
(12) Patent Application Publication
(10) Pub. No.: US 2018/0356691 A1
(43) Pub. Date: Dec. 13, 2018

(54) METHOD AND APPARATUS FOR ADJUSTING POLARIZING PLATES IN PREPARING PROCESS OF PHOTO-ALIGNMENT FILM

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Qiyang LI, Beijing (CN); Wenqiang WANG, Beijing (CN)

(21) Appl. No.: 15/562,706

(22) PCT Filed: Apr. 1, 2017
(86) PCT No.: PCT/CN2017/079711

§ 371 Date: Sep. 28, 2017

(30) Foreign Application Priority Data
Jul. 27, 2016 (CN) 201610603151.5

(51) Int. Cl. G02F 1/1337; G01J 4/04

(52) U.S. Cl. CPC G02F 1/133788; G01J 4/04

(57) ABSTRACT

A method and apparatus for adjusting polarizing plates in the preparing process of photo-alignment films are provided. The method for adjusting the polarizing plates in the preparing process of the photo-alignment films includes: allowing light emitted from a light source to travel through a first polarizing plate to form a polarized light, the first polarizing plate being a polarizing plate to be adjusted; allowing the polarized light to travel through a second polarizing plate; adjusting a direction of a transmission axis of the second polarizing plate, and measuring a light intensity of the transmitted light traveled through the second polarizing plate; and adjusting a direction of a transmission axis of the first polarizing plate according to the measured light intensity, so that the direction of the transmission axis of the first polarizing plate can be parallel to a predetermined direction

### TECHNICAL FIELD

At least one embodiment of the present disclosure relates to a method and an apparatus for adjusting polarizing plates in a preparing process of photo-alignment films.

### BACKGROUND

The thin-film transistor liquid crystal display (TFT-LCD) has currently become the most important display apparatus in people's lives instead of the cathode ray tube (CRT) display, and achieves the replacement from spherical and heavy design to planar and thin and light design. With the rapid development of information industry in recent years, especially the rise of Internet technology, the concept trend, such as “Internet of things” and “mobility” emerges, and people are no longer satisfied with the user experience brought by the usual liquid crystal display (LCD) and expect to get thinner, lighter and more realistic novel display apparatus.

As the core field of LCD, alignment technology mainly includes two modes, namely rubbing-alignment and photo-alignment. Rubbing-alignment technology has simple process and is easy to achieve industrial production, however, the dust and electrostatic problems always bother engineers. Particularly, the current market requires TFT-LCD products to have high display characteristics, such as high PPI and high contrast, so the rubbing-alignment technology cannot meet the requirement. So people begin to look for a new alignment process. The basic principle of photo-alignment technology is to utilize the anisotropy produced by the photochemical reaction of ultraviolet sensitive polymer and monomer materials, to achieve the orientation arrangement of liquid crystal molecules and complete the alignment process.

### SUMMARY

At least one embodiment of the present disclosure relates to a method and an apparatus for adjusting polarizing plates in the preparing process of photo-alignment films, which can improve the adjustment preciseness of the polarizing plates and are simple and easy to operate

At least one embodiment of the present disclosure provides a method for adjusting polarizing plates in the preparing process of photo-alignment films, comprising: allowing light emitted from a light source to travel through a first polarizing plate to form a polarized light, in which the first polarizing plate is a polarizing plate to be adjusted; allowing the polarized light to travel through a second polarizing plate; adjusting a direction of a transmission axis of the second polarizing plate, and measuring a light intensity of the transmitted light traveled through the second polarizing plate; and adjusting a direction of a transmission axis of the first polarizing plate according to the measured light intensity, so that the direction of the transmission axis of the first polarizing plate is parallel to a predetermined direction.

At least one embodiment of the present disclosure also provides an apparatus for adjusting polarizing plates in the preparing process of photo-alignment films, comprising: a light source configured to emit light; a clamp unit configured to clamp a first polarizing plate, in which the first polarizing plate is a polarizing plate to be adjusted; a detection unit comprising a second polarizing plate and a light intensity measuring device, in which the clamp unit is provided between the second polarizing plate and the light source, and the light intensity measuring device is configured to record a light intensity of light traveled through the first polarizing plate and the second polarizing plate in sequence; and an adjustment unit configured to adjust a direction of a transmission axis of the second polarizing plate and configured to adjust a direction of a transmission axis of the first polarizing plate provided on the clamp unit, so that the direction of the transmission axis of the first polarizing plate is parallel to a predetermined direction.

### BRIEF DESCRIPTION OF THE DRAWINGS

In order to demonstrate clearly technical solutions of the embodiments of the present disclosure, the accompanying drawings in relevant embodiments of the present disclosure will be introduced briefly. It is apparent that the drawings may only relate to some embodiments of the disclosure and not intended to limit the present disclosure.

FIG. 1 illustrates a polarizing plate adjustment mode (top view);

FIG. 2 illustrates a polarizing plate adjustment mode (front view);

FIG. 3 is a flow chart of a method for adjusting polarizing plates in the preparing process of photo-alignment films, provided by one embodiment of the present disclosure;

FIG. 4 is a diagram illustrating the adjustment principle of the method for adjusting the polarizing plates in the preparing process of the photo-alignment films, provided by embodiments of the present disclosure;

FIG. 5 is a schematic diagram of the method for adjusting the polarizing plates in the preparing process of the photo-alignment films, provided by one embodiment of the present disclosure;

FIG. 6 is a schematic diagram of a method for adjusting polarizing plates in the preparing process of photo-alignment films, provided by another embodiment of the present disclosure;

FIG. 7 is a schematic diagram illustrating the instance that the first polarizing plate is not required to be adjusted in the method for adjusting the polarizing plates in the preparing process of the photo-alignment films, provided by an embodiment of the present disclosure;

FIG. 8 is a schematic diagram of the preparing process of a photo-alignment film, provided by one embodiment of the present disclosure;

FIG. 9 is a schematic diagram illustrating the process of calibrating the second polarizing plate in the preparing process of the photo-alignment films, provided by one embodiment of the present disclosure;

FIG. 10 is a schematic diagram of the apparatus for adjusting polarizing plates in the preparing process of the photo-alignment films, provided by one embodiment of the present disclosure;

FIG. 11 is a schematic diagram of the apparatus for adjusting polarizing plates in the preparing process of photo-alignment films, provided by one embodiment of the present disclosure;

FIG. 12 is a schematic diagram of the control unit in the apparatus for adjusting the polarizing plates in the preparing process of the photo-alignment films, provided by another embodiment of the present disclosure; and

FIG. 13 is a schematic diagram of the guide rail unit in the apparatus for adjusting the polarizing plates in the preparing process of the photo-alignment films, provided by another embodiment of the present disclosure.

Reference numerals of the accompanying drawings:
001—polarizing plate; 002—polarizing plate holder; 003—mounting portion; 004—guide rail; 005—LED light source; 006—camera probe; 11—light source; 12—clamp unit; 121—first polarizing plate; 13—detection unit; 131—second polarizing plate; 132—light intensity measuring device; 14—adjustment unit; 15—control unit; 151—first servomotor; 152—second servomotor; 133—cavity; 141—first adjusting portion; 142—second adjusting portion; 17—guide rail unit; 171—first guide rail; 172—second guide rail; 1711, 1712—guide rail.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is apparent that the described embodiments are just a part but not all of the embodiments of the disclosure. Based on the described embodiments herein, those skilled in the art can obtain other embodiment(s), without any creative work, which shall be within the scope of the disclosure.

Unless otherwise defined, all the technical and scientific terms used herein have the same meanings as commonly understood by one of ordinary skill in the art to which the present disclosure belongs. The terms, such as “first,” “second,” or the like, which are used in the present disclosure, are not intended to indicate any sequence, amount or importance, but for distinguishing various components. Also, the terms, such as “a,” “an,” “the/said,” or the like, are not intended to limit the amount, but for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

An liquid crystal display (LCD) panel generally comprises an array substrate, an opposed substrate, and a liquid crystal layer disposed between the array substrate and the opposed substrate. The array substrate and the opposed substrate are arranged opposite to each other. The opposed substrate and the array substrate are respectively upper and lower substrates of the display panel. A display structure, such as a thin-film transistor (TFT) array, is usually formed on the array substrate, and color resin is usually formed on the opposed substrate. For instance, the opposed substrate is a color filter (CF) substrate.

In-plane switching (IPS) mode is a display mode of in-plane switching of liquid crystal molecules. Compared with the other two modes, IPS has advantages of large viewing angle, true color and perfect dynamic image quality. The array substrate and the opposed substrate of an IPS LCD panel normally include an alignment film, respectively. The alignment film is configured to induce the alignment of liquid crystal molecules. It should be noted that the LCD panel requiring the alignment films is not limited to the IPS mode and may also be other modes.

In the photo-alignment technology, an ultraviolet polarized light is formed by irradiating a polarizing plate with an ultraviolet light. According to the polarization principle, the ultraviolet light traveled through the polarizing plate and polymer monomer materials (e.g., polyimide materials) are subjected to photochemical reaction (e.g., photopolymerization, photoisomerization, or photodissociation) to produce anisotropy, so as to induce the alignment of liquid crystal molecules. In the photochemical reaction process, only photosensitive groups in parallel to the polarization direction of the polarized light are subjected to a photochemical reaction, and molecules arranged not in parallel to the polarization direction of the polarized light do not undergo the photochemical reaction, so a structure similar to a molecule “groove” is formed and can induce the orientation arrangement of the liquid crystal molecules. As a core optical element in the photo-alignment technology, the polarizing plate has the function of polarizing the ultraviolet light. Therefore, the adjustment preciseness of the polarizing plate is particularly important and directly affects the alignment angle of TFT-LCD products. For instance, the polarizing plate may use a wire grid.

The usual polarizing plate adjustment method mainly includes the following three parts: an LED light source, an external camera and a slide rail device (sharing one slide rail with a photo-alignment device).

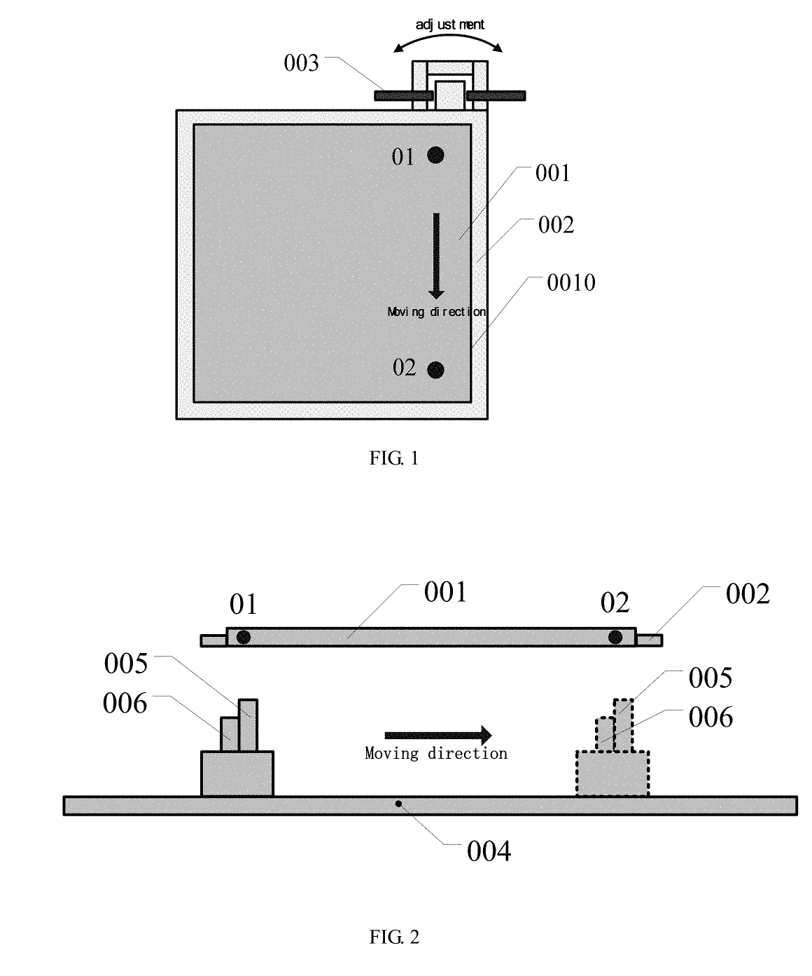

As shown in FIG. 1, a polarizing plate 001 is fixed in a polarizing plate holder 002; the polarizing plate holder 002 is adjustably mounted on a clamp unit (not shown in the figure) through a mounting portion 003; and the mounting portion 003, for instance, includes a screw.

The usual polarizing plate adjustment method is as follows: with reference to the standard line 0010 of a polarizing plate holder, as shown in FIG. 2, firstly, an LED light source 005 and a camera 006 are moved to a first point 01 (position 1); and secondly, the LED light source 005 and the camera 006 are moved to a second point 02 (position 2) along the moving direction of a stand of a photo-alignment device (e.g., the moving direction of the stand is the extension direction of a guide rail 004); whether a straight line formed by the two points is parallel to the moving direction of the stand is checked. At this point, the travel route of the polarizing plate may be monitored by the camera (as shown in FIGS. 1 and 2). If the travel route of the polarizing plate is not parallel to the standard line, it is required that an engineer adjusts the polarizing plate and rotates the screw 003 to the best position. If the travel route of the polarizing plate is parallel to the standard line, no adjustment is required. The method has simple principle, namely it determines whether the polarizing plate is at the best position according to the determination that whether the travel route of the polarizing plate is parallel to the standard line, or not. But the adjustment method has complex process and low preciseness.

In an embodiment of the present disclosure, the polarizing plate is placed in a holder, and the direction of a transmission axis of the polarizing plate may be adjusted by rotating the holder. The direction of the transmission axis in each polarizing plate is same, namely the transmission axis of each polarizing plate is along one direction.

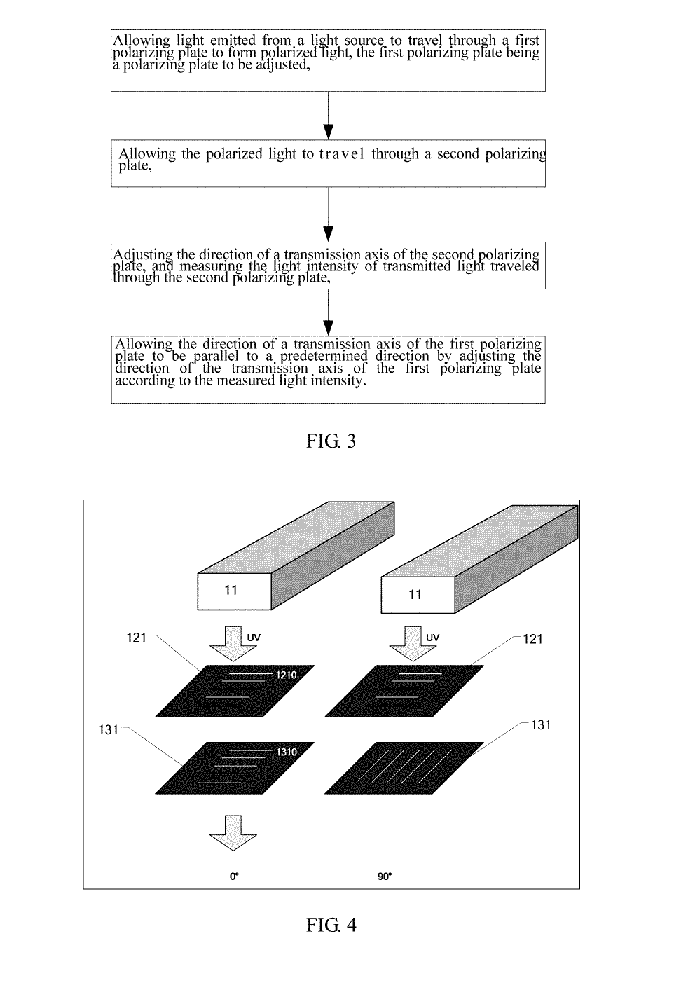

As shown in FIG. 3, at least one embodiment of the present disclosure provides a method for adjusting polarizing plates in the preparing process of photo-alignment films, which comprises: allowing light emitted by a light source to travel through a first polarizing plate to form a polarized light, in which the first polarizing plate is a polarizing plate to be adjusted; allowing the polarized light to travel through a second polarizing plate; adjusting the direction of a transmission axis of the second polarizing plate, and measuring the light intensity of transmitted light traveled through the second polarizing plate; and allowing the direction of a transmission axis of the first polarizing plate to be parallel to a predetermined direction by adjusting the direction of the transmission axis of the first polarizing plate according to the measured light intensity.

For instance, in the embodiment of the present disclosure, in the process of adjusting the direction of the transmission axis of the first polarizing plate, the first polarizing plate may rotate in a plane where the first polarizing plate is located, so as to adjust the direction of the transmission axis of the first polarizing plate; and in the process of adjusting the direction of the transmission axis of the second polarizing plate, the second polarizing plate may rotate in a plane where the first polarizing plate is located, so as to adjust the direction of the transmission axis of the second polarizing plate. Embodiments of the present disclosure are not limited thereto.

The method for adjusting the polarizing plates in the preparing process of the photo-alignment films according to the at least one embodiment of the present disclosure, does not require complex adjusting processes of the conventional polarizing plate adjustment method, instead, it can determine whether optical parameters of the apparatus satisfy the requirements, or not, according to an included angle formed between the transmission axis of the first polarizing plate and the transmission axis of the second polarizing plate directly, and adjust the direction of the transmission axis of the first polarizing plate by the polarization principle of light, which improves the adjustment preciseness of the polarizing plate, and improves the product performance.

Description will be given below to the adjustment principle of the method for adjusting the polarizing plates in the preparing process of the photo-alignment films, provided by at least one embodiment of the present disclosure.

The polarization of light is an inherent characteristic of optical waves. According to Maxwell's theory of electromagnetic waves, the optical waves are transverse waves, and its electrical vector is perpendicular to the propagation direction. The transverse vector characteristic of light is called the polarization of light. The expression is:

E=E₀e^{i(Kr-ωt)} Formula 1

If the direction of the electric field amplitude E₀ never changes in the propagation process, the light is referred to a linearly polarized light. The plane formed by the electric vector E₀ and the light propagation direction K is defined as the vibration plane, and the vibration plane of the linearly polarized light is always constant, so the light is referred to a plane polarized light. Light emitted by an ordinary light source is a monochromatic wave series produced by the vibration of dipole moments in various directions. The synthesized result behaves like natural light, which can be regarded as light with equal probability and magnitude of vibration in all directions. Compared with the photo-alignment device, ultraviolet light emitted by the light source is equivalent to natural light, and the ultraviolet light is converted into a linearly polarized light after traveled through the polarizing plate.

For any fixed polarizing component, after natural light travels through the polarizing component, the vibration direction of the emitted linearly polarized light is constant, and the direction of the polarizing component which allows the light vector to travel therethrough is the transmission axis of the polarizing component. When natural light vertically travels through two polarizing components, the first polarizing component refers to a polarizer and the second one refers to an analyzer. The function of the polarizer is to convert natural light into linearly polarized light consistent with the transmission axis of the polarizer. If the transmission axis of the analyzer is parallel to the transmission axis of the polarizer, polarized light obtained after polarization may travel therethrough (as shown on the left side of FIG. 4); and if the transmission axis of the analyzer is perpendicular to the transmission axis of the polarizer, no light will travel therethrough at this point, and this state is referred to extinction (as shown on the right side of FIG. 4). When the analyzer rotates around the direction of incident light as an axis, the output light intensity will change. Given the intensity before the light being incident into the polarizer is I, the relationship between the transmitted intensity It and an included angle α between the transmission axes of the two polarizing components is:

It=I cos α Formula 2

The above is only theoretical. Actually, even the transmission axes of the two polarizing components are perpendicular to each other, complete extinction cannot be achieved. In order to illustrate the quality standards of the polarizing components, a polarizing component capable of producing near linearly polarized light is selected as the polarizer, meanwhile, the measured polarizing component is used as the analyzer; at this point, the analyzer is rotated, and the maximum light intensity output value and the minimum light intensity output value may be obtained. The ratio of the maximum light intensity output value Imax to the minimum light intensity output value Imin is defined as extinction ratio E_{R}.

E_{R}=Imax/Imin Formula 3

As shown in FIG. 4, light, e.g., ultraviolet light, emitted from a light source 11 travels through a first polarizing plate 121 and reaches a second polarizing plate 131. As shown on the left side of FIG. 4, the direction 1210 of the transmission axis of the first polarizing plate 121 is parallel to the direction 1310 of the transmission axis of the second polarizing plate 131. As shown on the right side in FIG. 4, the direction 1210 of the transmission axis of the first polarizing plate 121 is perpendicular to the direction 1310 of the transmission axis of the second polarizing plate 131. In the embodiment of the present disclosure, the first polarizing plate 121 is the polarizer, and the second polarizing plate 131 is the analyzer. The embodiment of the present disclosure adopts the light polarization principle, and adjusts the first polarizing plate according to an included angle between the direction 1210 of the transmission axis of the first polarizing plate 121 and the direction 1310 of the transmission axis of the second polarizing plate 131.

In the embodiment of the present disclosure, when the direction of the transmission axis of the second polarizing plate is parallel to the direction of the transmission axis of the first polarizing plate, the rotation angle of the second polarizing plate is defined as 0° (as shown on the left side in FIG. 4); and when the direction of the transmission axis of the second polarizing plate is perpendicular to the direction of the transmission axis of the first polarizing plate, the rotation angle of the second polarizing plate is defined as 90° (as shown on the right side in FIG. 4).

For instance, the first polarizing plate and the second polarizing plate may be wire grids.

In one embodiment of the present disclosure, the predetermined direction includes but not limited to the moving direction of the stand of the photo-alignment device. The direction of the transmission axis of the first polarizing plate may be adjusted to be parallel to, or perpendicular to the reference direction. For instance, the reference direction includes but not limited to the moving direction of the stand of the photo-alignment device. For instance, the position of the first polarizing plate may be adjusted with reference to the direction of the transmission axis of the second polarizing plate, but not limited thereto.

In one embodiment of the present disclosure, the light intensity of transmitted light after traveled through the second polarizing plate may be measured by an illuminometer, and the light emitted by the light source travels through the first polarizing plate and the second polarizing plate in sequence and reaches the illuminometer.

Two examples for adjusting the direction of the transmission axis of the first polarizing plate are given below. By any of the two examples, the direction of the transmission axis of the first polarizing plate can be adjusted to be parallel to the moving direction of the stand of the photo-alignment device. In the embodiments of the present disclosure, the negative sign before angle indicates opposite rotation. For instance, in the embodiments of the present disclosure, in the process of adjusting the first polarizing plate and the second polarizing plate, the negative angle indicates counterclockwise rotation, and the positive angle indicates clockwise rotation, but not limited thereto.

### First Example

The process of adjusting the direction of the transmission axis of the first polarizing plate 121 includes: moving the second polarizing plate 131 to a position under the first polarizing plate 121, adjusting the direction 1310 of the transmission axis of the second polarizing plate to be perpendicular to the moving direction of the stand of the photo-alignment device (90° position), and recording the light intensity to be I₀; rotating the second polarizing plate 131, recording the minimum light intensity Iₘᵢₙ, and recording the rotation angle θ1 of the second polarizing plate at the minimum Iₘᵢₙ, as shown in FIG. 5; if I₀=Iₘᵢₙ, the direction 1210 of the transmission axis of the first polarizing plate is just perpendicular to the direction 1310 of the transmission axis of the second polarizing plate, the first polarizing plate 121 is not needed to be adjusted; if I₀>Iₘᵢₙ, adjusting the first polarizing plate 121 according to the rotation angle −θ1.

In this way, the adjustment of one first polarizing plate can be performed. Likewise, the adjustment of all the first polarizing plates can be performed.

As shown in FIG. 5, when I₀>Iₘᵢₙ, after the direction 1310 of the transmission axis of the second polarizing plate 131 is rotated for the angle of θ1, the direction 1310 of the transmission axis of the second polarizing plate is perpendicular to the direction 1210 of the transmission axis of the first polarizing plate, so the adjustment of the first polarizing plate can be performed by rotating the direction 1210 of the transmission axis of the first polarizing plate for the angle of −θ1. The solid line in FIG. 5 refers to the direction of the transmission axis before rotation, and the dotted line refers to the direction of the transmission axis after rotation.

### Second Example

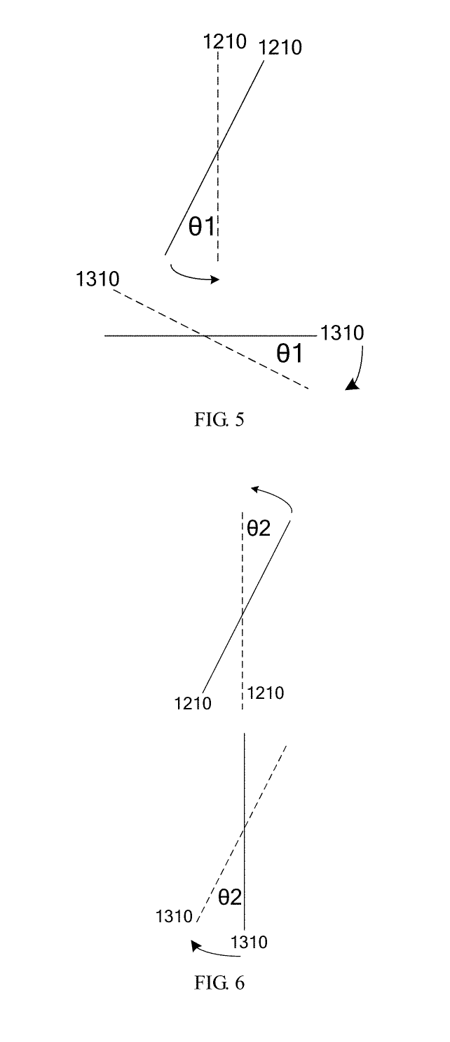

As shown in FIG. 6, the process of adjusting the direction of the transmission axis of the first polarizing plate includes: moving the second polarizing plate 131 to a position under the first polarizing plate 121, adjusting the direction 1310 of the transmission axis of the second polarizing plate to be parallel to the moving direction of the stand of the photo-alignment device (0° position), and recording the light intensity to be I₀; rotating the second polarizing plate 131, recording the maximum light intensity Iₘₐₓ, and recording the rotation angle θ2 of the second polarizing plate 131 at the maximum light intensity Iₘₐₓ; if I₀=Iₘₐₓ, the direction 1210 of the transmission axis of the first polarizing plate is just parallel to the direction 1310 of the transmission axis of the second polarizing plate, and the first polarizing plate 121 is not needed to be adjusted; and if I₀<Iₘₐₓ, adjusting the first polarizing plate 121 according to the rotation angle −θ2.

In this way, the adjustment of one first polarizing plate can be performed. Likewise, the adjustment of all of the first polarizing plates can be performed.

As shown in FIG. 6, when I₀<Iₘₐₓ, after the direction 1310 of the transmission axis of the second polarizing plate is rotated for the angle of θ2, the direction 1310 of the transmission axis of the second polarizing plate is parallel to the direction 1210 of the transmission axis of the first polarizing plate, so the adjustment of the first polarizing plate can be performed by rotating the direction 1210 of the transmission axis of the first polarizing plate for the angle of −θ2. The solid line in FIG. 6 refers to the direction of the transmission axis before rotation, and the dotted line refers to the direction of the transmission axis after rotation.

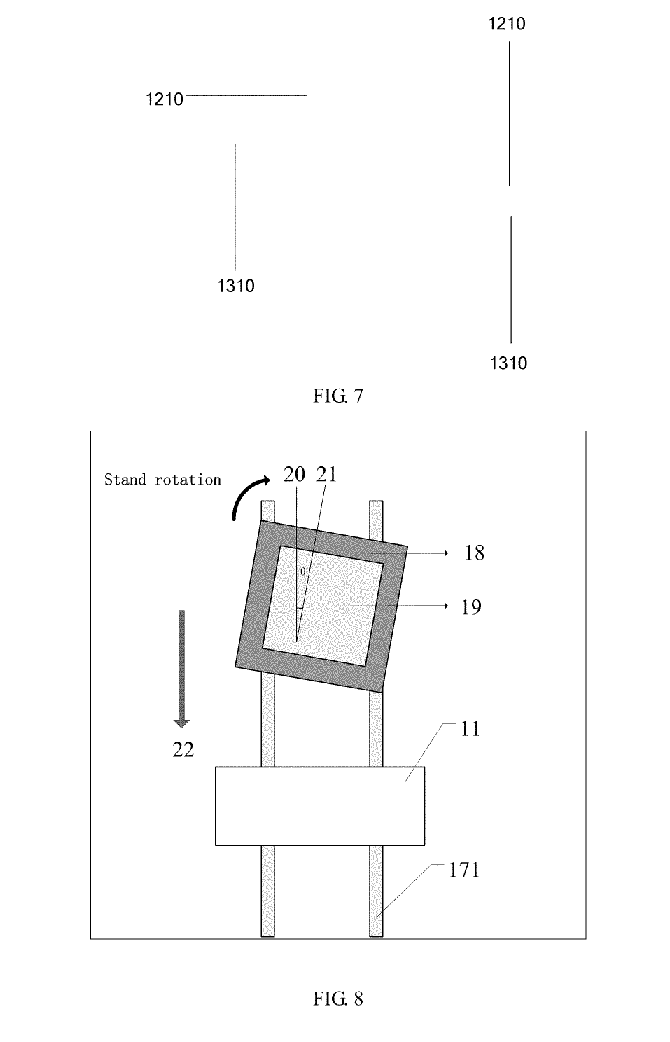

The left side of FIG. 7 shows the situation that the direction 1210 of the transmission axis of the first polarizing plate is just perpendicular to the direction 1310 of the transmission axis of the second polarizing plate when I₀=Iₘᵢₙ in the first example. The right side of the FIG. 7 shows the situation that the direction 1210 of the transmission axis of the first polarizing plate is just parallel to the direction 1310 of the transmission axis of the second polarizing plate when I₀=Iₘₐₓ.

It should be noted that the adjustment of the direction of the transmission axis of the first polarizing plate is not limited to the above two examples and may also adopt other methods.

For instance, in order to measure the light intensity of transmitted light traveled through the second polarizing plate when the direction of the transmission axis of the first polarizing plate is parallel to, or perpendicular to the direction of the transmission axis of the second polarizing plate, the rotation angle of the second polarizing plate may be ranged from −10° to 100°. For instance, the polarizing plate is rotated from 0° to −10° at first, and if not meeting the maximum, or minimum, the polarizing plate is rotated from −10° to 100°, which is not limited thereto.

The embodiment of the present disclosure can adjust the first polarizing plate with reference to the second polarizing plate. But the most basic standard is the alignment angle of products. The second polarizing plate and the alignment angle may be calibrated periodically.

In one embodiment of the present disclosure, the method for adjusting the polarizing plates in the preparing process of the photo-alignment films also comprises: calibrating the second polarizing plate according to the alignment angle of the prepared photo-alignment film.

The second polarizing plate may be calibrated periodically with respect to the moving direction of the stand (namely the alignment angle). For instance, the calibrating of the second polarizing plate according to the alignment angle of the prepared photo-alignment film includes: adopting the first polarizing plate for the preparing of the photo-alignment film, measuring the alignment angle of the prepared photo-alignment film, obtaining the deviation angle according to the difference between the alignment angle of the photo-alignment film and a predetermined alignment angle, and adjusting the direction of the transmission axis of the second polarizing plate according to the deviation angle.

The step of calibrating the second polarizing plate according to the alignment angle of the prepared photo-alignment film may be used for adjusting the second polarizing plate before the adjustment of the first polarizing plate, so as to adjust the first polarizing plate with reference to the second polarizing plate. That is to say, the second polarizing plate is located at the 90° position, or the 0° position. In this way, in the subsequent adjusting process, the second polarizing plate may be located at the 90° position, or the 0° position, or the second polarizing plate may be located at other positions by rotating it for a certain angle.

As shown in FIG. 8, a glass substrate 19 is placed on a stand 18 of the photo-alignment device and includes an alignment film to be aligned. The stand 18 of the photo-alignment device may be rotated for an angle θ, so that the alignment angle of the prepared photo-alignment film can be θ. The stand 18 of the photo-alignment device is disposed on a first guide rail 171 and moves along the extension direction of the first guide rail 171. In FIG. 8, the stand 18 of the photo-alignment device moves along a moving direction 22. When the stand 18 of the photo-alignment device passes below the light source 11, the alignment film to be aligned can be aligned. As shown in FIG. 8, an included angle between a direction 20 parallel to the moving direction of the stand 18 of the photo-alignment device and a direction 21 parallel to one side of the glass substrate after the rotation of the stand 18 of the photo-alignment device is θ.

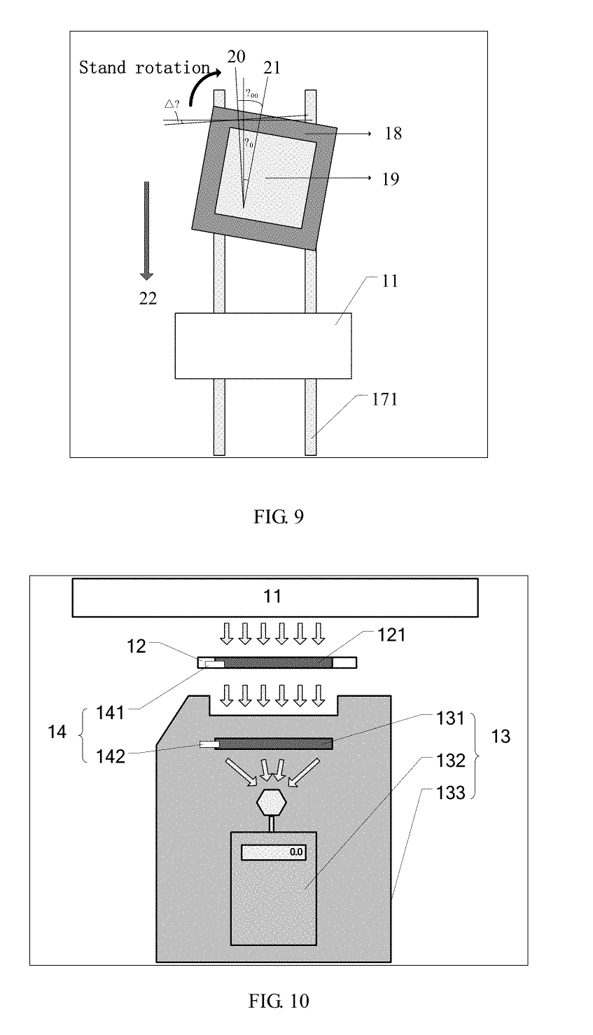

As shown in FIG. 9, the step of calibrating the second polarizing plate according to the alignment angle of the prepared photo-alignment film is as follows: firstly, adjusting the first polarizing plate with reference to the second polarizing plate; secondly, executing the preparing process of a glass substrate (each product has a specified alignment angle, and the specified alignment angle here is supposed to be θ₀), in which the alignment process of the alignment film to be aligned is performed at this point; finally, a photo-alignment inspection machine is utilized to measure the alignment angle, namely the alignment angle=θ₀₀. In this way, the deviation angle of the second polarizing plate is Δθ=θ₀₀−θ₀: At this point, the second polarizing plate is adjusted for the angle of Δθ, then the calibration process is completed. For instance, when a specified alignment angle of a product is θ₀=10° (for instance, the concept of 10° is that the stand of the photo-alignment device rotates clockwise for 10° at first and then moves along the extension direction of the stand), the alignment angle measured by the photo-alignment inspection machine is θ₀₀=10.4°, then, the second polarizing plate rotates counterclockwise for 0.4°. In this way, the calibration process is performed.

In the method for adjusting the polarizing plates in the preparing process of the photo-alignment films, provided by the embodiment of the present disclosure, the adjustment of the first polarizing plate may be performed by a servomotor connected with the first polarizing plate and/or the adjustment of the second polarizing plate may be performed by a servomotor connected with the second polarizing plate. In this way, the first polarizing plate and/or the second polarizing plate can rotate for a certain angle. For instance, the rotation angle is set on the servomotor, so that the first polarizing plate and/or the second polarizing plate can rotate for a given angle.

As illustrated in FIG. 10, at least one embodiment of the present disclosure also provides an apparatus for adjusting polarizing plates in the preparing process of photo-alignment films, which comprises: a light source 11 configured to emit light; a clamp unit 12 configured to clamp a first polarizing plate 121, in which the first polarizing plate 121 is a polarizing plate to be adjusted; a detection unit 13 including a second polarizing plate 131 and a light intensity measuring device 132, in which the clamp unit 12 is disposed between the second polarizing plate 131 and the light source 11, so that the light intensity measuring device 132 can be configured to record the light intensity of light traveled through the first polarizing plate 121 and the second polarizing plate 131 in sequence; and an adjustment unit 14 configured to adjust the direction of a transmission axis of the second polarizing plate 131 and configured to adjust the direction of a transmission axis of the first polarizing plate 121 disposed on the clamp unit 12, so that the direction of the transmission axis of the first polarizing plate 121 can be parallel to a predetermined direction.

In the apparatus for adjusting the polarizing plates in the preparing process of the photo-alignment films, provided by at least one embodiment of the present disclosure, the first polarizing plate 121 is equivalent to a polarizer, and the second polarizing plate 131 is equivalent to an analyzer. The light intensity measuring device 132 measures the transmitted intensity. The light emitted by the light source 11 travels through the first polarizing plate 121 at first and then travels through the second polarizing plate 132, finally, the light intensity measuring device 132 receives the light and measures the transmitted intensity.

The direction of the transmission axis of the first polarizing plate and the direction of the transmission axis of the second polarizing plate are adjusted by adjusting the holder position of the first polarizing plate 121 and the holder position of the second polarizing plate 131.

For instance, the light intensity measuring device 132 is an illuminometer which is configured to measure the light intensity of the light emitted by the light source 11 after traveled through the first polarizing plate 121 and the second polarizing plate 131 in sequence.

For instance, as shown in FIG. 10, the detection unit 13 also includes a cavity 133, and the second polarizing plate 131 and the light intensity measuring device 132 are disposed in the cavity 133.

For instance, as shown in FIG. 10, the adjustment unit 14 includes a first adjusting portion 141 and a second adjusting portion 142; the first adjusting portion 141 allows the first polarizing plate 121 to be adjustably mounted on the clamp unit 12; and the second adjusting portion 142 allows the second polarizing plate 131 to be adjustably mounted on the cavity 133.

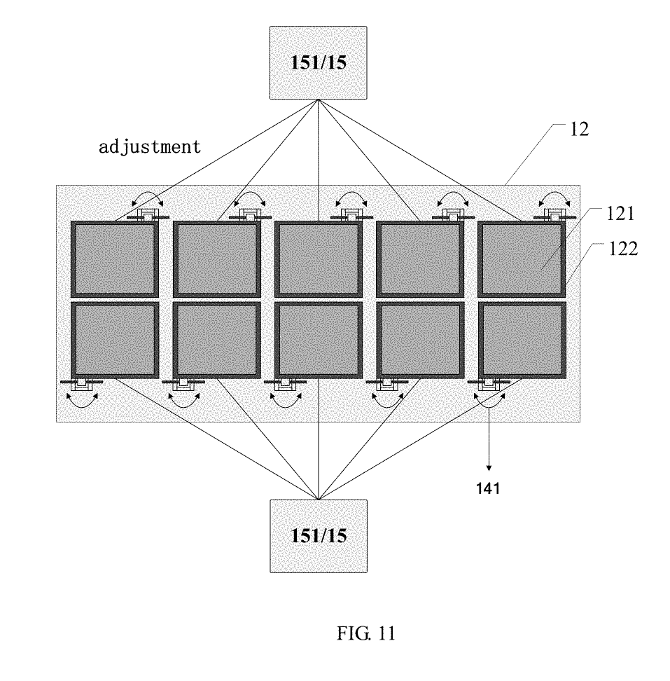

For instance, as shown in FIG. 11, the apparatus for adjusting the polarizing plates in the preparing process of the photo-alignment films also comprises a control unit 15 which is configured to control the adjustment unit 14.

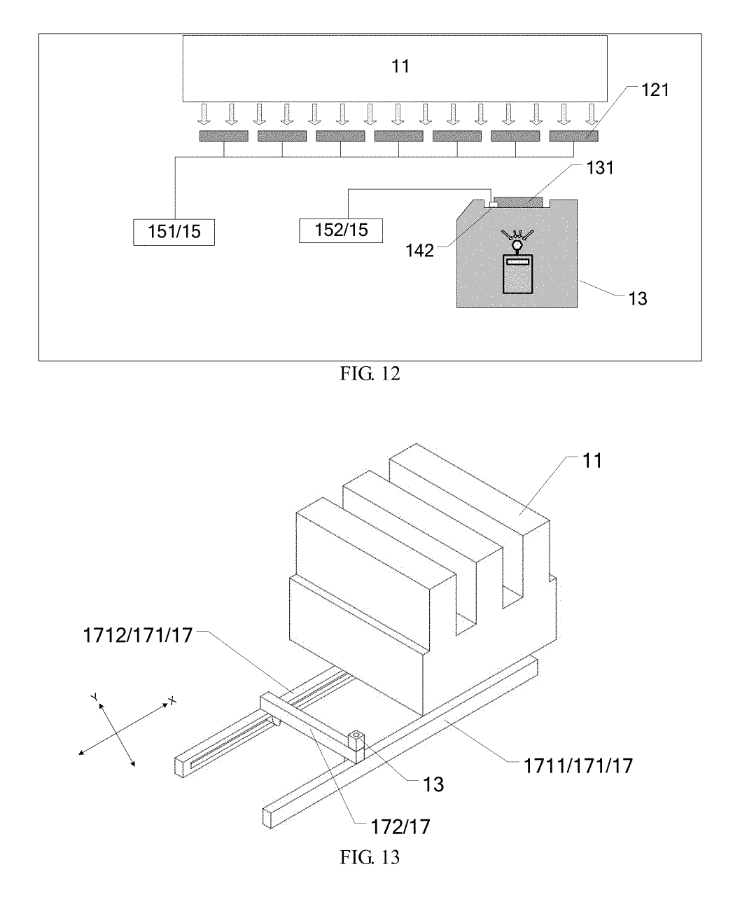

For instance, as shown in FIG. 12, the control unit 15 includes a first servomotor 151 and a second servomotor 152; the first servomotor 151 is configured to acquire the value of the illuminometer and adjust the direction 1210 of the transmission axis of the first polarizing plate; and the second servomotor 152 is configured to adjust the direction 1310 of the transmission axis of the second polarizing plate. By utilizing the automatic correction of a polarizing plate holder, the adjustment efficiency of the polarizing plate is improved, and the equipment utilization/activation can be improved. The holder of the first polarizing plate and/or the second polarizing plate may rotate automatically by using the feedback function, so that the optical parameters of the first polarizing plate can be within a specification range.

For instance, as shown in FIG. 13, the apparatus for adjusting the polarizing plates in the preparing process of the photo-alignment films also comprises a guide rail unit 17. The detection unit 13 is disposed on the guide rail unit 17 and may move on a plane defined by the guide rail unit 17.

For instance, as shown in FIG. 13, the guide rail unit 17 includes a first guide rail 171 and a second guide rail 172 which are perpendicular to each other; and the second guide rail 172 is disposed on the first guide rail 171 and may move along the extension direction of the first guide rail 171. The detection unit 13 may be disposed on the second guide rail 172. The first guide rail 171 includes two guide rails 1711 and 1712 parallel to each other.

In this way, the movement in the direction parallel to the moving direction of the stand (X direction) and perpendicular to the moving direction of the stand (Y direction) in the same plane can be realized. The adjustment unit may be randomly moved to the bottom of each first polarizing plate, so as to detect and adjust the polarizing plate.

For instance, in order to simplify the equipment, the light source 11 is also used for photo-alignment operation.

For instance, the predetermined direction includes but not limited to the moving direction of the stand of the photo-alignment device.

For those details in the apparatus for adjusting the polarizing plates in the preparing process of the photo-alignment films, provided by the embodiment of the present disclosure, which are same or similar to the method for adjusting the polarizing plates in the preparing process of the photo-alignment films, no further description will be given herein.

The method and the apparatus for adjusting the polarizing plates in the preparing process of the photo-alignment films, provided by at least one embodiment of the present disclosure, have at least one of the following advantages:

(1) High adjustment preciseness. The principle of a usual polarizing plate adjustment method is “whether the straight line determined by the two points is parallel to the moving direction of the stand, or not”. That is to say, an LED light source and a camera probe are mounted at the bottom of the polarizing plate. The two elements are moved so that the polarizing plate can be at a position parallel to a travel rail of the stand; and the alignment angle of the product can be guaranteed. The principle of the polarizing plate adjustment method provided by the embodiment of the present disclosure is to utilize the light polarization principle for adjustment. Compared with the usual macro-adjustment ways, this microscopic adjustment method can obtain higher adjustment preciseness of the polarizing plates. Particularly, for high-PPI products, the alignment angle plays a critical role in the optical performances, such as the contrast and afterimages of products, so the more precise polarizing plate adjustment method is particularly important.

(2) Simple adjustment ways. The usual polarizing plate adjustment method comprises the following steps: adjustment of the polarizing plate holder→polarization angle test→continue to adjust the polarizing plate holder according to the test result→secondary polarization angle test→completing polarizing plate adjustment until the polarization angle test complies with a standard. The process is cumbersome and complex and consumes long time (at least 40 hours needed). In the polarizing plate adjustment method provided by the embodiment of the present disclosure, the polarization angle not complying with the standard in the adjustment process can be directly detected, and automatically adjusted (about 1 hour needed) by using the feedback function. The process saves time greatly.

(3) Short adjustment period. The usual polarizing plate adjustment method consumes long time. In the parameter management process of the photo-alignment device, the process cannot be managed monthly, so the apparatus cannot be guaranteed to be always in the best condition. The polarizing plate adjustment method provided by the embodiment of the present disclosure can shorten the adjustment period due to its convenient adjustment ways, so as to allow that the apparatus to be always in the best condition and the product quality can be stable for a long period; and the process can be managed monthly.

(4) No pollution to the apparatus. For a TFT-LCD production line with high cleanliness, when the frequency of engineers entering the apparatus is higher, the impact on the degree of dust pollution in the apparatus is greater. The usual adjustment method requires multiple accesses to the apparatus and has the risk of polluting the apparatus. The polarizing plate adjustment method provided by the embodiment of the present disclosure does not require the engineers to enter the apparatus for adjustment, so it can effectively avoid the apparatus being polluted by dust.

(5) Less manual consumption. The usual polarizing plate adjustment method requires one engineer to control and check the operating state of the LED light source and the camera, and another engineer to manually adjust the polarizing plate. This process requires the engineers to have high operating techniques. The polarizing plate adjustment mode provided by the embodiment of the present disclosure does not require the access to the apparatus, and it has low requirement to the engineer, who just needs a simple training, which greatly save the human cost.

The following points should be noted:

(1) Unless otherwise defined, the same reference numeral in the embodiments of the present disclosure and the accompanying drawings thereof refers to the same element.

(2) The accompanying drawings in the embodiments of the present disclosure only involve structures relevant to the embodiments of the present disclosure, and other structures may refer to common design(s).

(3) Without conflict with each other, the features in different embodiments or the same embodiment of the present disclosure may be combined.

The foregoing is only the specific implementations of the present disclosure and not intended to limit the scope of the present disclosure. Any change or replacement that may be readily contemplated by those skilled in the art within the technical scope disclosed by the present disclosure shall fall within the scope of the present disclosure. Therefore, the scope of the present disclosure shall be defined by the claims.

The present application claims priority of the Chinese patent application No. 201610603151.5, filed on Jul. 27, 2016, the disclosure of which is incorporated herein by reference as part of the application.

1. A method for adjusting polarizing plates in a preparing process of photo-alignment films, comprising:
allowing light emitted from a light source to travel through a first polarizing plate to form a polarized light, in which the first polarizing plate is a polarizing plate to be adjusted;
allowing the polarized light to travel through a second polarizing plate;
adjusting a direction of a transmission axis of the second polarizing plate, and measuring a light intensity of the transmitted light traveled through the second polarizing plate; and
adjusting a direction of a transmission axis of the first polarizing plate according to the measured light intensity, so that the direction of the transmission axis of the first polarizing plate is parallel to a predetermined direction.

2. The adjusting method according to claim 1, wherein the predetermined direction comprises a moving direction of the stand of a photo-alignment device.

3. The adjusting method according to claim 1, wherein a light intensity of the transmitted light traveled through the second polarizing plate is measured by an illuminometer; and the light emitted from the light source travels through the first polarizing plate and the second polarizing plate in sequence and reaches the illuminometer.

4. The adjusting method according to claim 1, wherein a position of the first polarizing plate is adjusted with reference to the direction of the transmission axis of the second polarizing plate.

5. The adjusting method according to claim 4, wherein the adjusting of the direction of the transmission axis of the first polarizing plate comprises:
moving the second polarizing plate to a position under the first polarizing plate, adjusting the direction of the transmission axis of the second polarizing plate to be perpendicular to the moving direction of the stand of the photo-alignment device, and recording the light intensity to be I₀;
rotating the second polarizing plate, recording the minimum light intensity Iₘᵢₙ, and recording the rotation angle θ1 of the second polarizing plate at the minimum Iₘᵢₙ;
if I₀=Iₘᵢₙ, the first polarizing plate is not adjusted; and
if I₀>Iₘᵢₙ, adjusting the first polarizing plate according to the rotation angle −θ1.

6. The adjusting method according to claim 4, wherein the adjusting of the direction of the transmission axis of the first polarizing plate comprises:
moving the second polarizing plate to a position under the first polarizing plate, adjusting the direction of the transmission axis of the second polarizing plate to be parallel to the moving direction of the stand of the photo-alignment device, and recording the light intensity to be I₀;
rotating the second polarizing plate, recording the maximum light intensity Iₘₐₓ, and recording the rotation angle θ2 of the second polarizing plate at the maximum light intensity Iₘₐₓ;
if I₀=Iₘₐₓ, the first polarizing plate is not adjusted; and
if I₀<Iₘₐₓ, adjusting the first polarizing plate according to the rotation angle −θ2.

7. The adjusting method according to claim 5, further comprising: calibrating the second polarizing plate according to the alignment angle of the prepared photo-alignment film.

8. The adjusting method according to claim 6, wherein the calibrating of the second polarizing plate according to the alignment angle of the prepared photo-alignment film comprises:
preparing the photo-alignment film by using the adjusted first polarizing plate, measuring the alignment angle of the prepared photo-alignment film, obtaining a deviation angle according to the difference between the alignment angle of the photo-alignment film and a predetermined alignment angle, and adjusting the direction of the transmission axis of the second polarizing plate according to the deviation angle.

9. The adjusting method according to claim 5, wherein the rotation angle of the second polarizing plate is ranged from −10° to 100°.

10. An apparatus for adjusting polarizing plates in a preparing process of photo-alignment films, comprising:
a light source configured to emit light;
a clamp unit configured to clamp a first polarizing plate, in which the first polarizing plate is a polarizing plate to be adjusted;
a detection unit comprising a second polarizing plate and a light intensity measuring device, in which the clamp unit is provided between the second polarizing plate and the light source, and the light intensity measuring device is configured to record a light intensity of light traveled through the first polarizing plate and the second polarizing plate in sequence; and
an adjustment unit configured to adjust a direction of a transmission axis of the second polarizing plate and configured to adjust a direction of a transmission axis of the first polarizing plate provided on the clamp unit, so that the direction of the transmission axis of the first polarizing plate is parallel to a predetermined direction.

11. The adjusting apparatus according to claim 10, wherein the light intensity measuring device is an illuminometer which is configured to measure the light intensity of the light emitted from the light source after traveled through the first polarizing plate and the second polarizing plate in sequence.

12. The adjusting apparatus according to claim 10, further comprising a control unit, wherein the control unit is configured to control the adjustment unit.

13. The adjusting apparatus according to claim 12, wherein the control unit comprises a first servomotor and a second servomotor, the first servomotor being configured to obtain the value of the illuminometer and adjust the direction of the transmission axis of the first polarizing plate, and the second servomotor being configured to adjust the direction of the transmission axis of the second polarizing plate.

14. The adjusting apparatus according to claim 10, wherein the detection unit further comprises a cavity, the second polarizing plate and the light intensity measuring device being disposed in the cavity.

15. The adjusting apparatus according to claim 14, wherein the adjustment unit comprises a first adjusting portion and a second adjusting portion, the first adjusting portion allowing the first polarizing plate to be adjustably mounted on the clamp unit, and the second adjusting portion allowing the second polarizing plate to be adjustably mounted on the cavity.

16. The adjusting apparatus according to claim 10, further comprising a guide rail unit, wherein the detection unit is disposed on the guide rail unit and movable on a plane determined by the guide rail unit.

17. The adjusting apparatus according to claim 16, wherein the guide rail unit comprises a first guide rail and a second guide rail which are perpendicular to each other; and the second guide rail is disposed on the first guide rail and movable along the extension direction of the first guide rail.

18. The adjusting apparatus according to claim 10, wherein the light source is also configured to perform photo-alignment operation.

19. The adjusting apparatus according to claim 10, wherein the predetermined direction comprises the moving direction of the stand of the photo-alignment device.
